(19) United States
(12) Patent Application Publication
(10) Pub. No.: US 2026/0219047 A1
(43) Pub. Date: Jul. 30, 2026

(54) METHOD AND SYSTEM FOR IMPROVED COVERAGE PATH PLANNING

(71) Applicant: QUALCOMM Incorporated, San Diego, CA (US)

(72) Inventors: Jiong ZHAO, Suzhou (CN); Weizhang LUO, Shenzhen (CN); Jun LIU, Shenzhen (CN); Zhengjia ZHU, Guangzhou (CN); Zixiang WANG, Shenzhen (CN)

(21) Appl. No.: 19/145,491

(22) PCT Filed: Feb. 16, 2023
(86) PCT No.: PCT/CN2023/076358

§ 371 Date: Jul. 2, 2025

(51) Int. Cl. G01C 21/20

(52) U.S. Cl. CPC G01C 21/20

(57) ABSTRACT

A method and system for finding a preferred tour of a navigation map for a robotic device. An A*algorithm is used to generate a super adjacency list of the number of turns in shortest paths between pairs of map vertices and identifying preferred directions of each vertex to assign pheromone and heuristic values to vertices. Using a modified Ant Colony Optimization (ACO) algorithm paths through the map are traced by artificial “ants” to solve the tour problem using the heuristic and pheromone values until all vertices have been visited. The total distance and number of turns are calculated from the super adjacency list. A best fraction of paths based on distance and number of turns may be selected, the pheromone and heuristic values may be updated for vertices on those paths. A best path through the navigation map may be selected based on all iterations and provided as an output.

### BACKGROUND

Robotic devices that are capable of autonomous or semiautonomous operation are being developed for a variety of applications. Such robotic devices may be embodied in a variety of forms, such as in automated vacuum cleaners, mowers, unmanned aerial vehicles, and terrestrial vehicles. These robotic devices may be used for entertainment applications (e.g., toy robots), performing menial tasks (e.g., cleaning, mowing, etc.), in environments that are unfriendly to humans (e.g., space, deep water, cold temperature, etc.), etc.

An end-to-end (E2E) robot is a type of robot that is specifically designed to perform a specific set of tasks (e.g., mowing, cleaning, etc.) in a specific type of environment (e.g., yard, home, office, etc.) without human intervention. These robots may be equipped with sensors, brushes, suction, blades, or other tools to cut grass or remove dirt and debris from surfaces. Early E2E robots had important limitations such as difficulty avoiding collisions with objects and incomplete cleaning coverage. However, more sophisticated robots have been developed in recent years that are able to overcome some of these issues by creating a map of the environment and using a path planning algorithm to determine the path for the robot to follow. The robot may then execute its task as it moves through the environment (e.g., by using its onboard equipment to remove dirt and debris from surfaces, to cut grass, etc.).

### SUMMARY

Various aspects include methods and robotic devices implementing such methods for determining a path for the robotic device. Various aspects may include obtaining, by a processing device of the robotic device, a navigation map of an environment, in which the navigation map is divided into a grid of vertices, an adjacency list that identifies a distance between each vertex in the grid of vertices and each neighboring vertex that is adject to the vertex, and a super adjacency list that includes elements representing a shortest distance and path turns between each pair of vertices in the navigation map, using the super adjacency list to perform a modified Ant Colony Optimization (ACO) process that generates an ACO path for an ant that starts at a starting vertex and uses heuristic and pheromone values to determine the next vertex to visit until all vertices in the navigation map have been visited, determining a total distance and number of turns in the ACO path, repeating the operations of using the super adjacency list to perform the ACO process and determining the total distance and number of turns in the ACO path traced by an ant until a threshold number of iterations has been performed, sorting ACO paths by distance and number of turns, updating pheromone information associated with each vertex for a fraction of paths with best distance and turn information, and saving one or both of shortest or fastest ACO path in a current iteration.

Some aspects may further include repeating for a predetermined number of iterations the operations of using the super adjacency list to perform the modified ACO process that generates the ACO path, determining the total distance and number of turns in the ACO path, sorting ACO paths by distance and number of turns, updating pheromone information associated with each vertex for the fraction of paths, and saving one or both of shortest or fastest ACO path in the current iteration, comparing saved ACO paths to determine one or both of a shortest or fastest ACO path, and outputting one or both of a shortest or fastest ACO path.

Some aspects may further include dividing the navigation map into the grid of vertices, generating the adjacency list that identifies a distance between each vertex in the grid of vertices and each neighboring vertex that is adject to the vertex, and generating the super adjacency list that includes elements representing a shortest distance and path turns between each pair of vertices in the navigation map. In some aspects, generating the super adjacency list that includes elements representing a shortest distance and path turns between each pair of vertices in the navigation map may include using a A*process applied to the generated adjacency list and to generate the super adjacency list by determining a shortest path between each pair of vertices in the grid of vertices, determining a number of turns in each shortest path between each pair of vertices in the grid of vertices, and generating the super adjacency list to include the shortest path and the number of turns. In some aspects, generating the super adjacency list further may include determining a preferred direction of each vertex in the grid of vertices, and associating a weight value to the preferred direction of each vertex in the grid of vertices.

Some aspects may further include determining a pheromone value for each vertex in the grid of vertices, and determining a heuristic value for each vertex in the grid of vertices based on the pheromone value and the weight value of the preferred direction of each vertex in the grid of vertices, in which the determined pheromone value and determined heuristic value are used in the ACO process to determine the path for each ant in a subsequent iteration.

Some aspects include a computing device that includes a processor that may be configured to obtain a navigation map of an environment, divide the navigation map into a grid of vertices, generate an adjacency list that identifies a distance between each vertex in the grid of vertices and each neighboring vertex that is adject to the vertex, use the generated adjacency list and an A*process to generate a super adjacency list, and use the generated super adjacency list to determine a path through the grid of vertices that visits each vertex in the grid of vertices.

In some aspects, the processor may be configured to use the generated adjacency list and the A*process to generate the super adjacency list by determining a shortest path between each pair of vertices in the grid of vertices, determining a number of turns in each shortest path between each pair of vertices in the grid of vertices, and generating the super adjacency list to include the shortest path and the number of turns.

In some aspects, the processor may be further configured to determine the number of turns in each shortest path between each pair of vertices in the grid of vertices by: determining a preferred direction of each vertex in the grid of vertices, and associating a weight value to the preferred direction of each vertex in the grid of vertices.

In some aspects, the processor may be further configured to determine a pheromone value for each vertex in the grid of vertices, and determine a heuristic value for each vertex in the grid of vertices based on the pheromone value and the weight value of the preferred direction of each vertex in the grid of vertices. In some aspects, the processor may be configured to use the generated super adjacency list to determine the path through the grid of vertices that visits each vertex in the grid of vertices by selecting a vertex in the grid of vertices as a starting vertex, using the super adjacency list to perform a modified Ant Colony Optimization (ACO) process that generates an ACO path for the starting vertex that starts at the starting vertex and uses the heuristic and pheromone values to determine the next vertex to visit until all vertices in the grid of vertices have been visited, and determining a total distance and number of turns in the ACO path. In some aspects, the processor may be configured to repeat the operations of selecting the vertex in the grid of vertices as the starting vertex, using the super adjacency list to perform the modified ACO process that generates the ACO path, and determining the total distance and number of turns in the ACO path until all of vertices in the grid of vertices have been selected as the starting vertex and an ACO path has been generated for each vertex in the grid of vertices. In some aspects, the processor may be configured to: generate a sorted list of ACO paths based on the total distance and number of turns associated with each ACO path, update the pheromone value based on the total distance and number of turns associated with a subset of ACO paths in the sorted list of ACO paths, and store the shortest ACO path in the sorted list of ACO paths in memory.

Further aspects may include a computing device having a processor configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor to perform various operations corresponding to the method operations discussed above

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram of a cleaning robot operating within a communication system according to various embodiments.

FIG. 2 is a component block diagram illustrating components of a cleaning robot according to various embodiments.

FIG. 3 is a component block diagram illustrating an example processing device system on chip (SOC) suitable for use in cleaning robots implementing the various embodiments.

FIGS. 4A-4C are block diagrams that illustrate components and operations in a system configured to implement methods for improved coverage path planning in accordance with the various embodiments.

FIGS. 5A and 5B are process flow diagrams that illustrate a method of performing path planning in accordance with some embodiments.

FIG. 6 is a block diagram that illustrates logical components in a system configured to generate an adjacency list in accordance with some embodiments.

FIG. 7 is a block diagram that illustrates logical components in a system configured to calculate the shortest distance between each two vertexes in the navigation map that does not include any obstacles.

FIG. 8 is a block diagram that illustrates logical components in a system configured to calculate the shortest distance between each two vertexes in the navigation map that includes obstacles.

FIG. 9 is a block diagram that illustrates logical components in a system configured to calculate the shortest distance and number of turns in path between two vertices in accordance with some embodiments.

FIG. 10 is a block diagram that illustrates logical components in a system configured to generate a super adjacency list that identifies the shortest distance and number of turns between each two vertexes in a navigation map that does not include any obstacles.

FIG. 11 is a block diagram that illustrates logical components in a system configured to consider the preferred direction of a vertex for determining a path through a navigation map that includes obstacles in accordance with some embodiments.

FIG. 12 is a block diagram that illustrates logical components in a system configured to use weights for the preferred direction of the vertices in accordance with some embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and robotic devices that include computing devices configured to implement the methods, for navigating an environment for full path coverage to efficiently cover the entire environment. In some embodiments, the computing device may be configured to generate a navigation map of the robot's environment, divide the navigation map into a grid of smaller cells or “vertices,” and determine a path through a set of points or locations in the grid of vertices that reduces or minimizes the total distance traveled and/or the time required to visit all of the points/locations.

For example, the computing device may be configured to generate an “adjacency list” that includes all vertices in the navigation map and their neighbors. The computing device may use the generated adjacency list and an A* algorithm to generate a “super adjacency list.” The super adjacency list may include a measure of the number of turns in the shortest path between each pair of vertices that accounts for a preferred direction of each vertex, with a corresponding weight, for use in determining a heuristic value. In some embodiments, the computing device may use a modified Ant Colony Optimization (ACO) algorithm that, starting at a vertex, uses heuristic values and “pheromone values” to determine the next vertex to visit and repeat the process until all vertices have been visited and a total distance and number of turns have been calculated from the super adjacency list. The computing device may select a fraction (e.g., the top ten percent) of paths based on distance and number of turns, update the pheromone values on the edges of these paths, compare all saved paths, and select the path with the lowest total distance traveled or lowest time required to visit all of the points as the output. The output, which may be the shortest or quickest path through all of the vertices (points) on the map, may be referred to herein as a “preferred tour.”

Various embodiments overcome many of the limitations of conventional solutions. For example, by finding shortest or quickest paths through all of the vertices (points) on the map, various embodiments reduce the amount of time and/or power/energy required by a robotic device to traverse an environment. Accordingly, various embodiments may be implemented in current and future robotic systems to improve the efficiency, performance, and/or functionality of a robotic systems. Additional enhancements, improvements, and benefits will be evident from the disclosures below.

As used herein, the term “robotic device” refers to one of various types of robotic vehicles, robotic appliances, robots, etc. including an onboard processing device configured to provide some autonomous or semi-autonomous capabilities. In embodiments in which the robotic device is autonomous, the robotic device may include an onboard processing device configured to maneuver and/or navigate the robotic device without remote operating instructions (i.e., autonomously), such as from a human operator (e.g., via a remote computing device). In embodiments in which the robotic device is semi-autonomous, the robotic device may include an onboard processing device configured to receive some information or instructions, such as from a human operator (e.g., via a remote computing device), and autonomously maneuver and/or navigate the robotic device consistent with the received information or instructions. Various embodiments may be particularly useful for robotic devices configured to perform household tasks (e.g., vacuuming, mowing, security patrols, etc.).

As used herein, the terms “end-to-end robot” and “E2E robot” are used to refer to a robotic device configured to perform a specific task or set of tasks from start to finish without the need for human intervention, from mapping and path planning to execution of the task itself. An E2E robot may include any of a variety of different propulsion mechanisms, body designs, and component configurations suitable for use in a variety of different environments (e.g., on land, airborne, water-borne, etc.). E2E robots are typically equipped with a processor and/or an onboard processing device, sensors, actuators, and other hardware and software components that allow them to gather and process data, make decisions, and execute actions. E2E robots may also be connected to other systems, such as databases or cloud-based platforms, to access additional data or resources. The E2E robot may be able to gather all the necessary data, make decisions, and carry out actions on its own, without any input or guidance from a human operator.

As used herein, the term “cleaning robot” refer to any of a variety of robotic devices (e.g., E2E robotic devices) that are configured to perform specific cleaning tasks. Examples of cleaning robots include robotic vacuum cleaners, robotic lawn mowers, robotic window cleaners, and automated pool cleaners. Cleaning robots are typically equipped with cleaning components and a processor and/or an onboard processing device, sensors, and other hardware and software components that allow them to perform their specific set of tasks. For example, robotic lawn mowers may be equipped with blades to cut grass, mulching or bagging capabilities to collect clippings, sensors, and other hardware and software components that allow them to navigate around obstacles, detect grass and other plants, adjust their cutting height and path, etc. Similarly, a robotic vacuum cleaner may include sensors and other hardware and software components that allow them to navigate around obstacles, and components that perform cleaning functions, such as brushes, suction, or other tools to remove dirt and debris from surfaces.

For clarity and ease of reference, the various embodiments and examples are discussed below with reference to E2E robots or cleaning robots. However, it should be understood that the various embodiments may be implemented in any of a variety of mobile devices that include a processor and for which path planning, reducing the total distance traveled, and/or reducing the travel/operation time are important. As such, nothing in this application should be used to limit the claims to cleaning robots, E2E robots, or robotic devices unless expressly recited as such in the claims.

Generally, a cleaning robot may perform mapping operations to create a map of the area that it needs to clean. This map may include information about the layout of the environment, including the locations of obstacles, walls, and other objects. Once the map has been created, the robot may use a path planning algorithm to determine the best way to navigate through the environment and clean it efficiently. This may include finding a path that allows the robot to cover the entire map without missing any areas and/or finding a path that minimizes the distance the robot travels. The robot may then follow the planned path, using its sensors and onboard equipment to navigate around obstacles and avoid collisions. As it moves through the environment, the robot may perform various cleaning tasks, such as by using brushes and suction to remove dirt and debris from the surfaces it travels over.

A cleaning robot may implement or use any of a variety of path planning algorithms to find a path that allows the robot to cover the entire map without missing any areas. Examples of path planning algorithms include a bio-excitation network algorithm, A* algorithm, Ant Colony Optimization (ACO) algorithm, and Vertical Wave-Front algorithm.

Generally, a cleaning robot may use the bio-excitation network algorithm for image classification, object detection, path planning, and to navigate its environment. When used for path planning, conventional bio-excitation network solutions may include a high repetition rate and/or may suffer from poor performance in environments with multiple turns or changes in direction (due to a complexity known as a “multi-turn problem”). The high repetition rate may lead to inefficient cleaning, and the multi-turn problem could cause the robot to get stuck or take unnecessarily circuitous routes.

Various embodiments overcome these and other limitations of the bio-excitation network algorithm to reduce the repetition rate and improve the robot's performance in environments with multiple turns. In some embodiments, this may be accomplished by implementing or using a modified path planning algorithm with a modified cost function, and a new solution for generating candidate paths.

A cleaning robot may also use the A* algorithm for path planning. The A* algorithm combines a heuristic function, which estimates the distance to the goal, and a cost function, which measures the actual distance traveled, to guide the search for the “optimal path” from a starting point to a goal. When used for path planning, conventional A* algorithm solutions may have some important limitations. First, the A* algorithm is not a global search algorithm, which is important in full path planning because it allows an algorithm/system to consider the entire space of possible paths that the robot could follow, rather than just a local region around its current position. The A* algorithm also does not adequately address the multi-turn problem discussed above and/or may otherwise exhibit poor performance in some environments.

Various embodiments may overcome these and other limitations of conventional A* algorithm solutions by implementing or using a global search algorithm that allows the robotic device to find the most efficient path within the entire space of possible paths that the robot could follow. The global search algorithm may be a modified path planning algorithm with a modified cost function, and a new solution for generating candidate paths that reduces the repetition rate, improves the robot's performance in environments with multiple turns (e.g., overcomes the “multi-turn problem”). As such, various embodiments may reduce the overall time and energy required for the robot to reach its destination.

A cleaning robot may also use the Ant Colony Optimization (ACO) algorithm for path planning. The ACO algorithm is a type of optimization algorithm based on the behavior of ant colonies, which may be used by a robotic device to find a path through an environment or map. However, conventional ACO solutions are susceptible to the “multi-turn problem” discussed above, which may cause the robotic device to become stuck or take unnecessarily circuitous routes. In addition, conventional ACO solutions do not consider the cleaning efficiency of the cleaning robot in its path planning and do not prioritize paths that allow the cleaning robot to clean the environment more efficiently, such as by covering larger areas in a single pass or avoiding areas that have already been cleaned.

Various embodiments overcome these and other limitations of conventional ACO solutions to improve the robot's performance in environments with multiple turns (overcoming the “multi-turn problem”), account for the cleaning efficiency of the cleaning robot in path planning, and/or prioritize paths that allow the cleaning robot to clean the environment more efficiently. In some embodiments, this may be accomplished by implementing or using a modified path planning algorithm with a modified cost function, and a new solution for generating candidate paths.

Some embodiments may use the Vertical Wave-Front algorithm in conjunction with the ACO algorithm. The Vertical Wave-Front algorithm is a path planning algorithm that is based on the idea of building a “wave front” of nodes that expands outward from the starting point of the path. Conventional Vertical Wave-Front algorithm solutions are also susceptible to the “multi-turn problem” discussed above and do not consider the cleaning efficiency of the E2E robot in its path planning. By combining the ACO algorithm with the Vertical Wave-Front algorithm, some embodiments may overcome some of the limitations and disadvantages of conventional solutions discuss above to improve the overall performance and efficiency of the path planning system.

Generally, a navigation map is a representation of an environment or area that is used for path planning and other navigation tasks. The navigation map may be divided into a grid of smaller cells or nodes, each of which represents a small area within the environment. The cells may contain information about the features or obstacles in that area, such as walls, doors, or furniture. The navigation map may be used by a path planning algorithm to find the best path through the environment for a robot or other application. The algorithm may use the information in the map to avoid obstacles and find the most efficient route to the goal. The navigation map may also be updated as the robot moves through the environment, allowing it to adapt to new obstacles or changes in the layout of the environment.

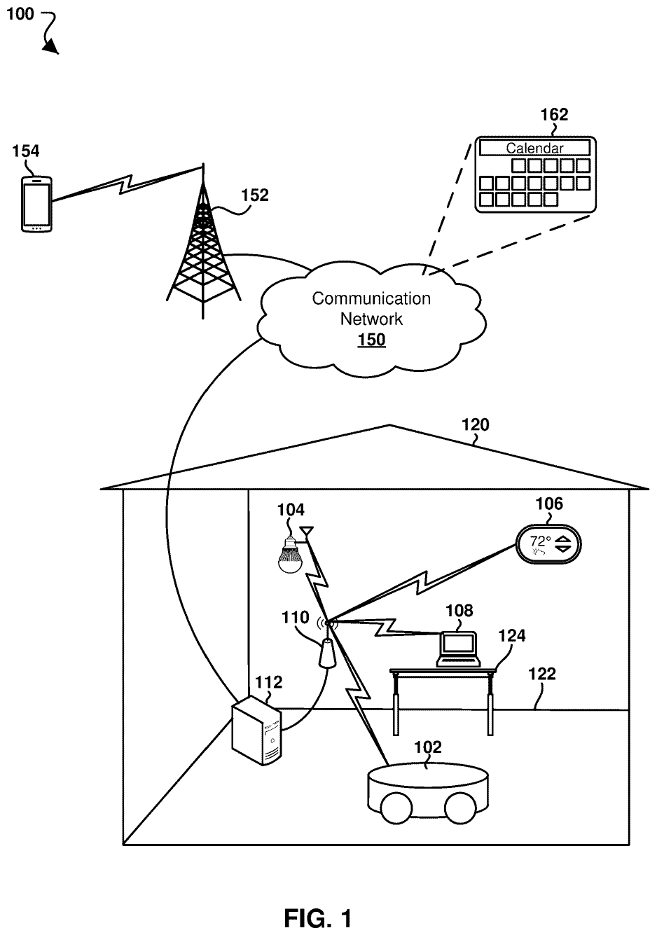

Various embodiments may be implemented within a robotic device operating within a variety of communication systems 100, an example of which is illustrated in FIG. 1. With reference to FIG. 1, the communication system 100 may include a cleaning robot 102, a smart lighting device 104, a smart thermostat device 106, and a mobile computing device 108, a hub device 110, and a wireless access point 112, any or all of which may be in or around a structure 120 that is associated with an area 122 to be cleaned, which may include various obstacles 124. In the example illustrated in FIG. 1, the communication system 100 also includes a communication network 150, base station 152, and mobile device 154.

The cleaning robot 102 may be configured to perform various cleaning tasks in locations within and proximate to the structure 120, including an interior location of the structure 120 (e.g., a room) or an exterior location of the structure 120 (e.g., lawn, backyard, garden, porch, balcony, etc.).

The wireless access point 112 may be configured to allow for wireless communications among the devices 102-110 in and around the structure 120. The hub device 110 may include a router, a gateway, or another suitable device that enables communication with the communication network 150, and ultimately the mobile device 154. The mobile device 154 may access the communication network 150 via the base station 152, which may include components configured to provide wireless communications over a wide area (e.g., macro cells) and/or small cells (e.g., micro cell, a femto cell, a pico cell, etc.). The communication network 150 may also include one or more network elements, such as servers and other similar devices (not illustrated separately in FIG. 1). The network elements may host and provide access to network-based services. For example, one or more such network elements may provide access to a network-based calendar 162, which may be accessible to the mobile device 154, associated with the cleaning robot 102, and/or used to schedule tasks for the cleaning robot 102.

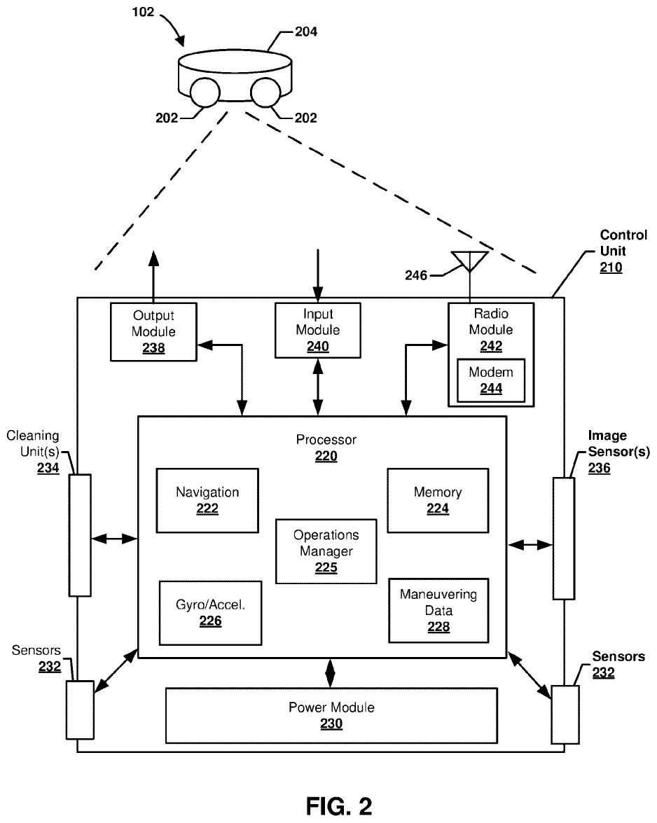

FIG. 2 illustrates components that may be included in a robotic device suitable for implementing various embodiments. With reference to FIGS. 1 and 2, a cleaning robot 102 may include a number of wheels 202 and a body 204. The frame 204 may provide structural support for the wheels 202.

A cleaning robot 102 may include a control unit 210 that may house various circuits and devices used to power and control the operation of the cleaning robot 102. In the example illustrated in FIG. 2, the control unit 210 includes a processor 220, a power module 230, sensors 232, cleaning units 234, image sensors 236 (e.g., optical sensor, camera, monocular camera, etc.), an output module 238, an input module 240, and a radio module 242 coupled to an antenna 246 and coupled to or including a modem 244. The processor 220 may include or be coupled to a navigation unit 222, a memory 224, an operations management unit 225, a gyro/accelerometer unit 226, and a maneuvering data module 228.

The cleaning robot 102 may be controlled through control of the individual motors of the wheels 202 as the cleaning robot 102 progresses toward a destination. The processor 220 may be configured with processor-executable instructions to control motion and other operations of the cleaning robot 102, including operations of various embodiments. For example, the processor 220 may receive data from the navigation unit 222 and use such data in order to determine the present position and orientation of the cleaning robot 102, as well as the appropriate course towards the destination or intermediate sites. In some embodiments, the navigation unit 222 and/or processor 220 may be configured to communicate with a server through a wireless communication link to receive data useful in navigation, provide real-time position reports, assess data, etc.

In some embodiments, the navigation unit 222 may include a global navigation satellite system (GNSS) receiver system (e.g., one or more global positioning system (GPS) receivers) enabling the cleaning robot 102 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), access points that use any of a number of short range RATs (e.g., Wi-Fi, Bluetooth, Zigbee, Z-Wave, etc.), cellular network sites, radio station, remote computing devices, other E2E robots, etc. In some embodiments, the navigation unit 222 may use signals received from recognizable RF emitters (e.g., AM/FM radio stations, Wi-Fi access points, and cellular network base stations) on the ground.

The memory 224 may store a navigation map, path planning calculations, sensor data, and other information for accomplishing the operations of various embodiments.

The operations manager 225 may be configured to schedule and control one or more operations of the cleaning robot 102, including various cleaning operations, path finding algorithms, and other operations of various embodiments.

The gyro/accelerometer unit 226 may include an accelerometer, a gyroscope, an inertial sensor, an inertial measurement unit (IMU), or other similar sensors useful for controlling the operations of the cleaning robot 102 and performing the operations of various embodiments.

The maneuvering data module 228 may be configured to provide motion control-related information such as orientation, attitude, speed, heading, and similar information that the navigation unit 222 may use for navigation purposes. For example, the maneuvering data module 228 may include or receive data from the gyro/accelerometer unit 226 that provides data regarding the orientation and accelerations of the cleaning robot 102 that may be used in navigation, positioning, image processing, etc.

The power module 230 may include one or more batteries that may provide power to various components, including the processor 220, the sensors 232, the cleaning unit(s) 234, the image sensor(s) 236, the output module 238, the input module 240, and the radio module 242. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging.

The sensors 232 may include wheel rotation sensor, a radio frequency (RF) sensor, a barometer, an acoustic sensor, etc. useful for navigation, path planning, or otherwise performing cleaning tasks. The processor 220 may receive information from one or more image sensors 236 and/or other sensors 232, which may be used for navigation and/or for controlling cleaning operations. For example, images of surfaces may be used by the processor 220 to determine a level or intensity of clean operations (e.g., brush speed or pressure) to apply to a given location.

The cleaning units 234 may include components that enable the cleaning robot 102 to perform cleaning operations, such as in response to commands from the control unit 210. In various embodiments, the cleaning units 234 may include brushes, vacuums, wipers, scrubbers, dispensers for cleaning solution, and other suitable cleaning mechanisms. In various embodiments, the cleaning units 234 may include blades to cut grass, mulching capabilities, and/or bagging capabilities to collect clippings.

The image sensors 236 may include optical sensors, such as a camera (e.g., a monocular camera, etc.) that are suitable for collecting information regarding the environment in which the cleaning robot 102 operates.

The output module 238 may be configured to generate the outputs of the various embodiments and/or control signals for managing the motors that drive the rotors 202 and other components.

The input module 240 may be configured to inputs in accordance with the various embodiments, such as to receive input for controlling the motors and/or other components of the cleaning robot 102, receive images or data from an onboard camera or sensor, or receive electronic signals from other components (e.g., a payload).

The radio module 242 may be configured to receive navigation signals and provide such signals to the processor 220 and/or the navigation unit 222 to assist in navigation. The radio module 242 may include or be coupled to a modem 244 and a transmit/receive antenna 246. The radio module 242 may be configured to conduct wireless communications with a variety of wireless communication devices, examples of which include a wireless telephony base station or cell tower, a network access point, a beacon, a smartphone, a tablet, or another computing device with which the cleaning robot 102 may communicate. The processor 220 may establish a bi-directional wireless communication link with a wireless communication device (e.g., access point 110) using the modem 244 and the antenna 246 of the radio module 242 and via a transmit/receive antenna 292. In some embodiments, the radio module 242 may be configured to support multiple connections with different wireless communication devices using different radio access technologies.

While various components of the control unit 210 are illustrated in FIG. 2 as separate components, some or all of the components may be integrated together in a single processing device, system on chip (SOC), system in a package (SIP), etc.

Some of the detailed aspects of a cleaning robot 102 that would be known to one of skill in the art are omitted from FIG. 2 for ease of description and illustration. For example, it should be understood that in various embodiments the frame 204 may also include or provide structural support for various motors, sensors, cleaning mechanisms (e.g., a rotating brush, a vacuum, etc.), control panels, buttons, displays, batteries, charging units, etc. Further, while the illustrated cleaning robot 102 includes wheels 202, it should be understood that the wheels 202 are merely exemplary and various embodiments may include any variety of components to provide propulsion and maneuvering capabilities, such as treads, tracks, paddles, skids, or any combination thereof or of other components.

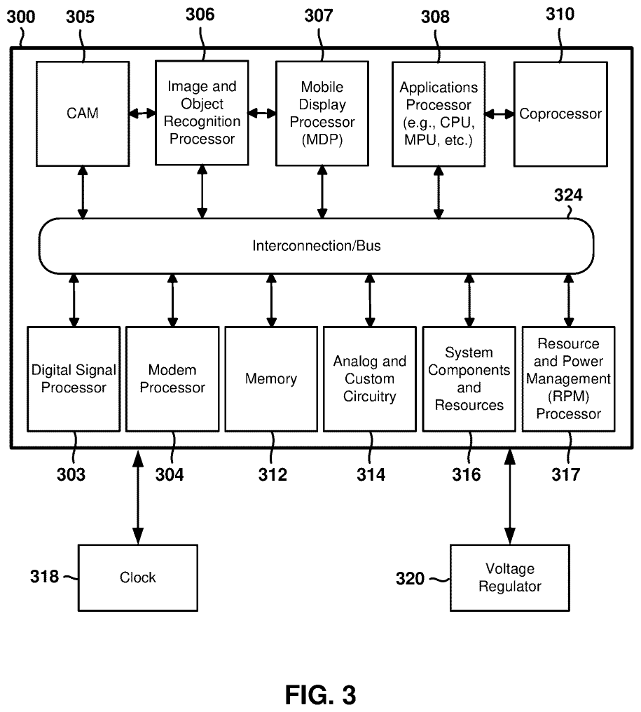

FIG. 3 illustrates a processing device SOC 300 that may be included in a cleaning robot (e.g., the cleaning robot 102 illustrated in FIGS. 1 and 2, etc.) and configured to perform improved coverage path planning operations in accordance with the various embodiments.

With reference to FIGS. 1-3, the processing device SOC 300 may include a number of heterogeneous processors, such as a digital signal processor (DSP) 303, a modem processor 304, an image and object recognition processor 306, a mobile display processor (MDP) 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317. Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

In some embodiments, one or more of the heterogeneous processors 303, 304, 306, 307, 308, 317 may be configured to implement all or portions of the control unit 210 of the cleaning robot 102.

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry (CAM) 305 that includes, provides, controls and/or manages the operations of one or more image sensor(s) 236 (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from image sensor(s) 236 via the CAM 305 to recognize and/or identify obstacles, generate navigation maps, and otherwise perform functions of the cleaning robot described. In some embodiments, the processor 306 may be configured to process external sensor data and perform functions of the object detection layer 202 as described.

The system components and resources 316, analog and custom circuitry 314, and/or CAM 305 may include circuitry to interface with peripheral devices, such as image sensor(s) 236, various sensors 232 (e.g., detection and ranging sensors), electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit 210 for use in a robot. The control unit may include communication links for communication with a telephone network, the Internet, and/or a network server as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

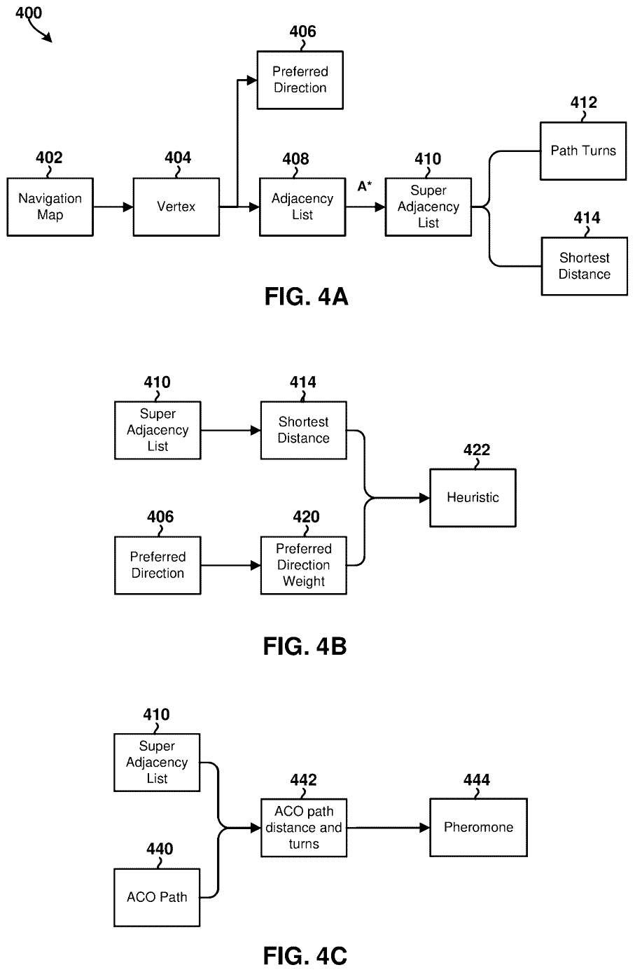

FIGS. 4A-4C illustrate components and operations in a system 400 configured to implement methods for improved coverage path planning in accordance with the various embodiments. In the examples illustrated in FIGS. 4A-4C, the system 400 includes a navigation map 402 component, a vertex 404 component, a preferred direction 406 component, an adjacency list 408 component, a super adjacency list 408 component, a path turns 412 component, a shortest distance 414 component, a preferred direction weight 420 component, a heuristic 422 component, an ACO path 440 component, an ACO path distance and turns 442 component, and a pheromone 444 component. Each of the components 402-444 in the system may include data or information structures that may be stored in memory and/or accessed or used by processors in a computing system (e.g., cleaning robot 102, control unit 210, processing device SOC 300, etc.).

With reference to FIGS. 1-4A, a processing device may generate and store a navigation map 402 of an environment (e.g., area to be cleaned, lawn to be mowed, etc.), divide the navigation map into a grid of smaller cells or vertices 404, and determine and store a preferred direction 406 (e.g., vertical, horizontal, etc.) for each vertex 404.

The processing device may generate and store an adjacency list 408 that includes all the vertices 404 in the navigation map 402 and all the neighbors of all the vertices 404 in the navigation map 402. That is, the adjacency list 408 may be an information structure that describes each vertex 404 and a set of neighbors for each vertex 404. In some embodiments, the adjacency list 408 may be an array of linked lists, with each element in the array representing a vertex 404 and the linked list associated with that element representing the set of neighbors for that vertex 404.

The processing device may use an A* algorithm and the adjacency list 408 to generate a super adjacency list 410, which may be an information structure that includes elements that represent the shortest distance 414 and path turns 412 between each pair of vertices 404 in the navigation map 402. That is, the processing device may calculate the shortest distance 414 or the shortest path between each pair of vertices 404 or for every possible combination of two vertices 404 in the navigation map 402, and determine the path turns 412 by determining the number of turns in the determined shortest distance 414 or shortest path. The processing device may then generate or update the super adjacency list 410 to include the shortest distance 414 and path turns 412 between every pair of vertices 404 in the navigation map 402.

With reference to FIGS. 1-4B, the processing device may determine the shortest distance 414 based on the generated super adjacency list 410, determine a preferred direction weight 420 based on the preferred direction 406, and determine a heuristic 422 based on the shortest distance 414 and preferred direction weight 420. The heuristic 422 may be value or information structure that indicates a distance between a current vertex and a goal vertex, or which represents the attractiveness of a particular path and/or the attractiveness of an edge between two vertices.

With reference to FIGS. 1-4C, the processing device may perform an ACO method to determine an ACO path 440, use the generated super adjacency list 410 and the ACO path 440 to determine the ACO path distance and turns 442, and generate or update a pheromone 444 based on the ACO path distance and turns 442. The pheromone 444 may be a value or information structure that indicates the attractiveness of a particular path and/or the attractiveness of an edge between two vertices.

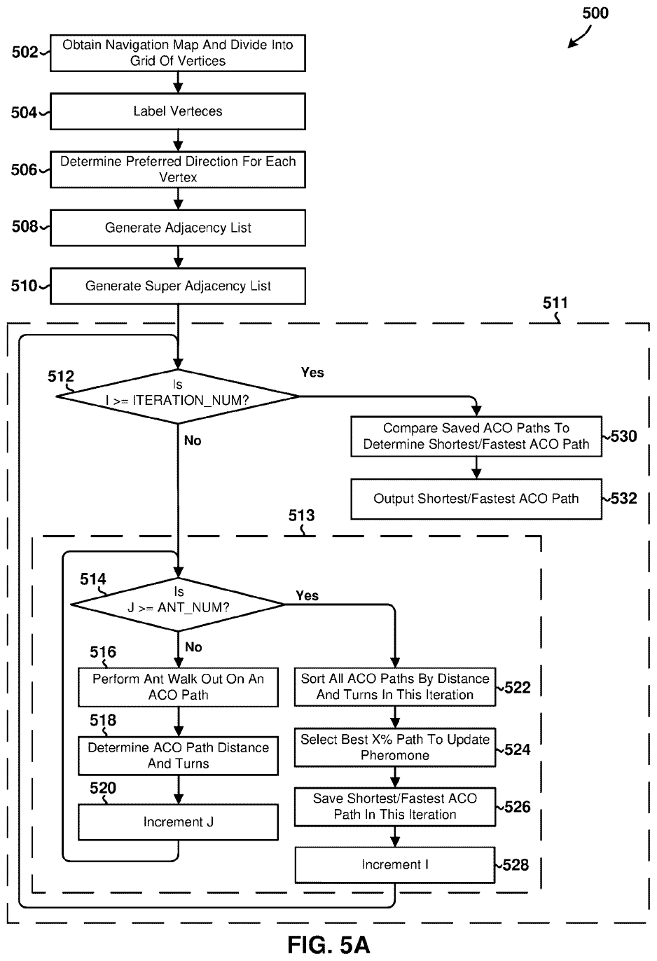

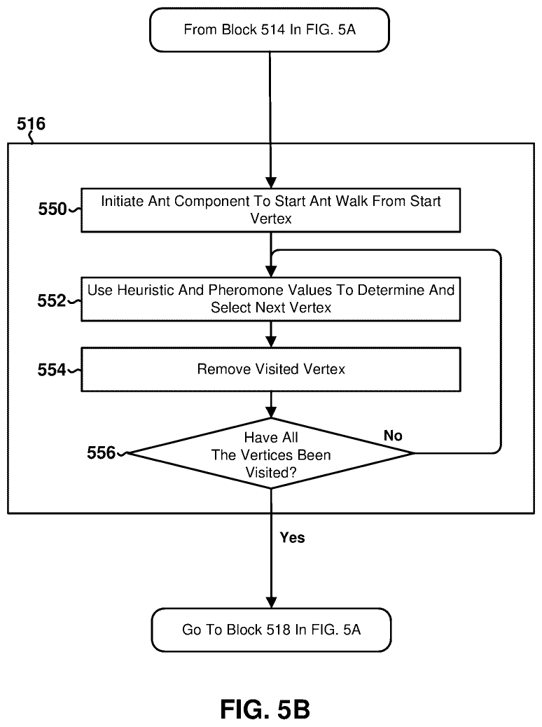

FIGS. 5A and 5B illustrate a method 500 of path planning in accordance with some embodiments. Method 500 may be performed by processing device suitable for use in a cleaning robot 102 (e.g., control unit 210, processing device SOC 300, etc.). With reference to FIGS. 1-5A, means for performing functions of the method 500 may include a processing device, such as the control unit 210 or processing device SOC 300 of a cleaning robot 102.

In block 502, the processing device may obtain a navigation map and divide the navigation map into a grid of vertices. In some embodiments, the processing device may obtain the navigation map by receiving the map from (or accessing) internal memory or from an external memory such as via a wireless communication link with an access point or base station. In some embodiments, the processing device may obtain the navigation map by generating the navigation map (or portions of the map) by analyzing information obtained by sensors, such as cameras, radar, LIDAR, etc. and storing the information in a map database format. As described, a navigation map is a representation of an environment or area that is used for path planning and other navigation tasks. In embodiments in which the navigation map is received from a memory, the map may already be divided into a grid of vertices. As part of the operations in block 502, the processing device may divided a generated navigation map (or a map received with memory that has not been divided) into a grid of smaller cells or nodes defined by vertices, each of which represents a small area within the environment. The cells may contain information about the features or obstacles in that area, such as walls, doors, or furniture. The navigation map may be used by a path planning algorithm to find the best path through the environment for a robot or other application.

In block 504, the processing device may label each vertex or assign a unique identifier to each vertex in the navigation map. In embodiments in which the navigation map has been stored in memory (connect to the processing device or remote), the vertex labeling may have been performed at the time the map was generated with vertex identifiers included within the navigation map data.

In block 506, the processing device may determine a preferred direction for each vertex. In some embodiments, the processing device may assign a corresponding weight to each vertex for use in determining a heuristic value associated with preferred directions of each vertex. In some embodiments, each direction may include a corresponding weight, with the preferred direction having a greatest weight, such as a weight of 0.83 when the sum of all direction weights equals to 1.

In block 508, the processing device may generate an adjacency list (e.g., adjacency list 408, etc.) that includes all vertices and their neighbors. In some embodiments, the adjacency list may be an array of linked lists, with each element in the array representing a vertex and the linked list associated with that element representing the set of neighbors for that vertex.

In block 510, the processing device may generate a super adjacency list (e.g., super adjacency list 410, etc.) that includes elements representing the shortest distance and the number of path turns between each pair of vertices in the navigation map. For example, the processing device may use an A* algorithm and the adjacency list generated in block 508 to determine the shortest distance/path between each pair of vertices (or for every possible combination of two vertices in the navigation map) and/or to determine the number of turns in the shortest distance/path. The processing device may generate the super adjacency list to include each vertex, its neighbors, shortest path/distance from each vertex to each neighbor, and the number of turns in the path from each vertex to each neighbor. Said another way, the elements in the super adjacency list may represent the shortest distance and “path turns” between each pair of vertices, in which the “path turns” are a measure of the number of turns in the shortest path between each pair of vertices.

In embodiments in which the navigation map has been stored in memory (connect to the processing device or remote), the operations of blocks 502-510 may have been performed at the time the map was generated and stored in memory, with vertex identifiers, preferred directions, the adjacency list and the super adjacency list included in one or more data structures provided with or within the navigation map data. In such embodiments, the processing device may accomplish the operations in blocks 502-510 by obtaining the navigation map data and accessing the data structures storing the vertex identifiers, preferred directions, the adjacency list and the super adjacency list.

After obtaining the navigation map, vertex identifiers, preferred directions, adjacency list and super adjacency list, either from a memory or by performing the operations in blocks 502-510, the processing device may perform operations to identify a preferred tour by iterating though a nested loop encompassed by blocks 512-532. In loops 511 and 513, the processing device may perform an ACO algorithm that uses a number of artificial ants (ANT_NUM) to search for the shortest full coverage path. Each artificial ant may start at a vertex and use heuristic and pheromone values to determine the next vertex to visit until all vertices have been visited and a total distance and number of turns have been calculated from the super adjacency list. In some embodiments, each “artificial ant” may be a software process or thread.

In some embodiments, the processing device may set the value of the variables I and J to zero in block 510. In determination block 512, the processing device may determine whether an iteration is complete by determining whether the value of I is greater than or equal to an iteration number (ITERATION_NUM). In some embodiments, the processing device may set the iteration number equal to the number of vertices in the navigation map.

In response to determining that I is less than the iteration number (i.e., determination block 512=“No”), and thus the iteration should continue, the processing device may determine whether all of the artificial ants have completed their tours through the navigation map or whether the value of J is greater than or equal to the number of artificial ants that are to be used to traverse the paths through the navigation map (ANT_NUM) in determination block 514.

In response to determining that J is less than the number of artificial ants (i.e., determination block 514=“No”), the processing device may determine that not all of the artificial ants have yet completed their tours and cause the next artificial ant to perform an ant walk out on an ACO path in block 516. As mentioned above and discussed in more detail with reference to FIG. 5B, the ACO algorithm uses a swarm of artificial ants (e.g., software objects, processes, etc.) to search for a suitable path. In the ACO algorithm each ant starts at a vertex and uses heuristic and pheromone values to determine the next vertex to visit. The processing device may continue this process of routing artificial ants through the navigation map until each ant has visited all vertices, at which point the processing device may calculate the total distance and number of turns of paths traversed by the artificial ants in block 518.

In block 518, the processing device may determine the ACO path distance and turns. In block 520, the processing device may increment the value of J. The processing device may perform operations 514-520 repeatedly until all of the artificial ants have completed their tours (or until each artificial ant has completed its walk out operations).

In response to determining that J is greater than or equal to the number of artificial ants (i.e., determination block 514=“Yes”), the processing device may determine that all of the artificial ants have completed their tours and sort all of the ACO paths by distance and turns in block 522. That is, after all ants have completed their tours, the processing device may sort the paths in block 522 based on distance and number of turns, and the path with the shortest total distance and the fewest number of turns may be selected or identified by the processing device. The path with the shortest total distance and/or the fewest number of turns may sometimes be referred to as the “preferred tour.”

In block 524, the processing device may select the top X % (e.g., 10%, etc.) of paths based on distance and number of turns. Also in block 524 the processing device may update the pheromone value based on the selected X % of paths.

In block 526, the processing device may save the shortest and/or fastest paths identified in the current iteration or loop 513. That is, the processing device may save a best ACO path found in the current iteration.

In block 528, the processing device may increment variable I to indicate that one iteration has been completed. The processing device may perform the operations 514-528 repeatedly until all the vertices in the navigation map have been visited or until the value of I is greater than or equal to the ITERATION_NUM.

In response to determining that I is greater than or equal to the iteration number (i.e., determination block 512=“Yes”), the processing device may determine in block 530 that all iterations are complete and compare all of the saved paths to determine and select a path through the vertices (e.g., a set of points or locations) that minimizes the total distance and/or the amount of time required to visit all of the points/locations. This path may be the preferred tour.

In block 532, the processing device may output the selected path or preferred tour (i.e., the shortest or quickest path through all of the vertices/points on the map). Thus, after all iterations are completed, the processing device may compare all of the saved paths and select the path with the shortest total distance and the fewest number of turns as the path for robotic device to follow. In some implementations, outputting the selected path or preferred tour may involve passing the path information to a navigation module within the processing device or other control unit of the robotic device for use in navigating the robotic device to accomplish and E2E operation (e.g., a cleaning robot performing cleaning operations in a room or building).

As described, the processing device may perform an ant walk out on an ACO path in block 516. FIG. 5B illustrates operations that the processing device could perform to accomplish ACO ant walk in block 516. With reference to FIGS. 1-5B, means for performing functions of the operations illustrated in FIG. 5B may include a processing device, such as the control unit 210 or processing device SOC 300 of a cleaning robot 102.

In block 550, the processing device may initiate an artificial ant component to start an ant walk out from a starting vertex. In block 552, the processing device may use the heuristic and pheromone values to determine and select the next vertex that the ant should visit. In some embodiments, the processing device may use the preferred direction (e.g., vertical or horizontal) of each vertex obtained in block 506. In some embodiments, each direction may include a corresponding weight, with the preferred direction having a weight of 0.83. When choosing the next vertex to visit, the processing device may use both the pheromone value determined in block 524 and the preferred direction weight between the current vertex and the next vertex to determine the heuristic value, which the processing device may use to select the next vertex to visit by the ant. In block 554, the processing device may remove the visited vertex from a list of vertices to visit in a given iteration.

In determination block 556, the processing device may determine whether all vertices have been visited by the artificial ant component. In response to determining that not all the vertices have been visited (i.e., determination block 556=“No”), the processing device may repeat the operations in blocks 552-556 until all the all the vertices have been visited and removed. In response to determining that all the vertices have been visited (i.e., determination block 556=“Yes”), the processing device may determine the ACO path distance and turns in block 518 (illustrated in FIG. 5A).

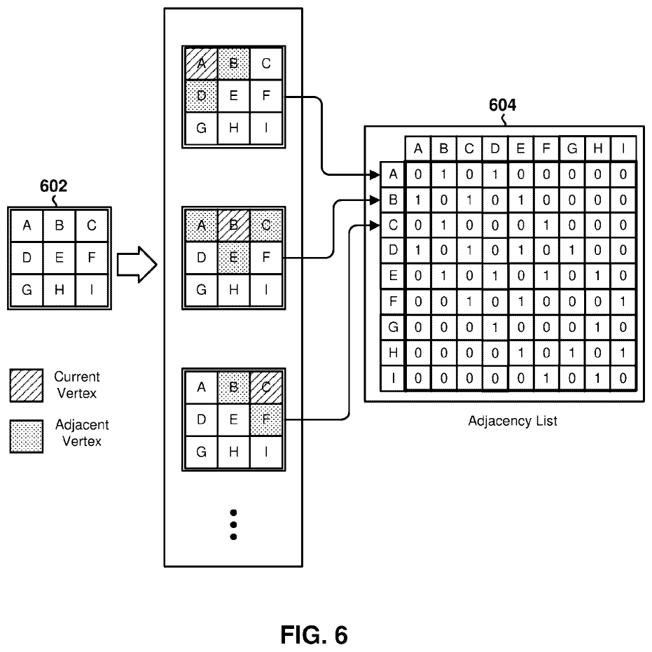

FIG. 6 illustrates logical components in a system configured to generate an adjacency list in accordance with some embodiments. With reference to FIGS. 1-6, a navigation map 602 may be divided into a grid of vertices (A, B, C, D, E, F, G, H, I). The processing device may select each vertex as a current vertex, determine its adjacent or neighboring vertices, and generate an adjacency list 604 that associates each vertex with its neighboring vertices. For example, the adjacency list 604 illustrated in FIG. 6 shows that the row for vertex A includes a value (1) in the columns for vertex B and vertex C. As such, the adjacency list 604 identifies vertices B and C as being adjacent to vertex A. Similarly, the adjacency list 604 identifies vertices A, C and E as being adjacent to vertex B, vertices B and F as being adjacent to vertex C, and so on.

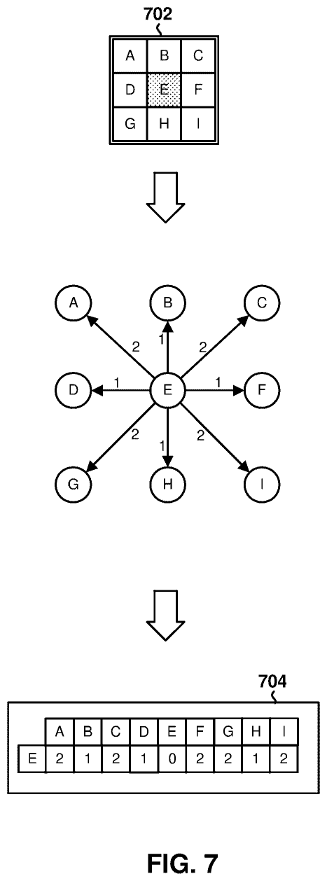

FIG. 7 illustrates logical components in a system configured to calculate the shortest distance between each two vertexes in the navigation map 702 that does not include any obstacles. With reference to FIGS. 1-7, the processing device may determine the distances between each vertex and every other vertex in the navigation. In the example illustrated in FIG. 7, the vertex E is selected and the distances between vertex E and all the vertices are included in a shortest distance list 704. The shortest distance list 704 includes information that indicates that the distance from vertex E to vertex A is 2, the distance from vertex E to vertex B is 1, the distance from vertex E to vertex C is 2, and so on.

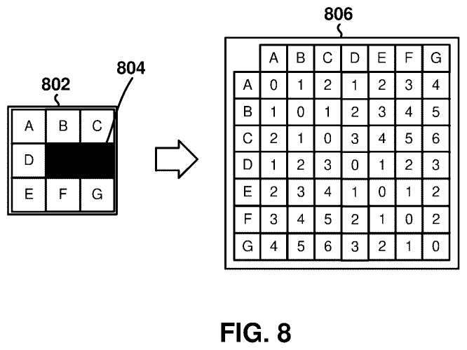

FIG. 8 illustrates logical components in a system configured to calculate the shortest distance between each two vertexes in the navigation map 802 that includes obstacles 804. In the example illustrated in FIG. 8, the shortest distance list 806 indicates that, for example, distance between vertex C and vertex G is six nodes (e.g., along path C->B->A->D->E->F->G). This is due to the obstacles 804 around with the robotic device will have to navigate.

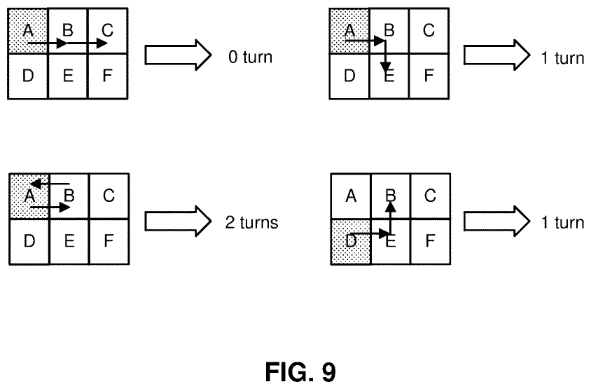

FIG. 9 illustrates logical components in a system configured to calculate the shortest distance and number of turns in accordance with some embodiments. In particular, the FIG. 9 illustrates that the path between vertex A and vertex C (e.g., A->B->C) includes two nodes (vertices) and zero turns. The path between vertex A and vertex E (e.g., A->B->E) includes two nodes and one turn. The path between vertex A and vertex B (e.g., A->B) includes one node and two turns. The path between vertex D and vertex B (e.g., D->E->B) includes two nodes and one turn.

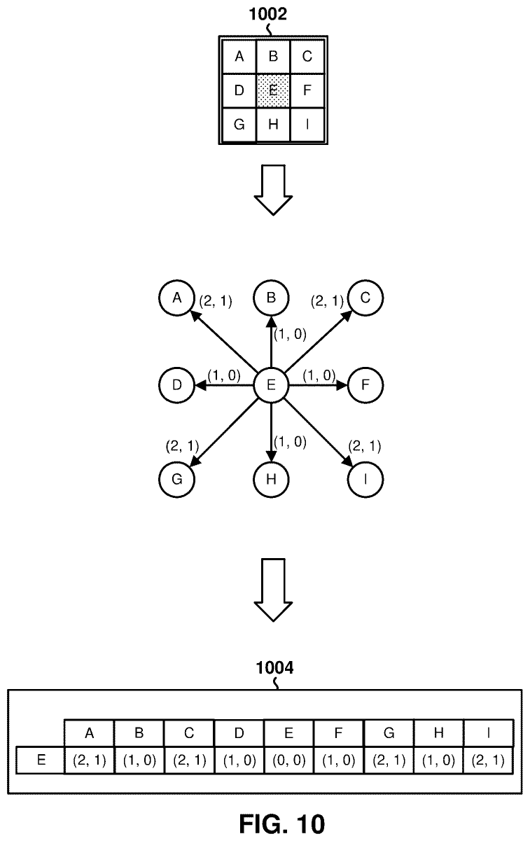

FIG. 10 illustrates logical components in a system configured to generate a super adjacency list 1004 that identifies the shortest distance and number of turns between each two vertexes in the navigation map 1002 that does not include any obstacles. In the example illustrated in FIG. 10, the super adjacency list 1004 includes a row for vertex E that indicates that the path from vertex E to vertex A includes two nodes and one turn (2, 1), the path from vertex E to vertex B includes one node an no turns (1, 0), the path from vertex E to vertex C includes two nodes and one turn (2, 1), etc.

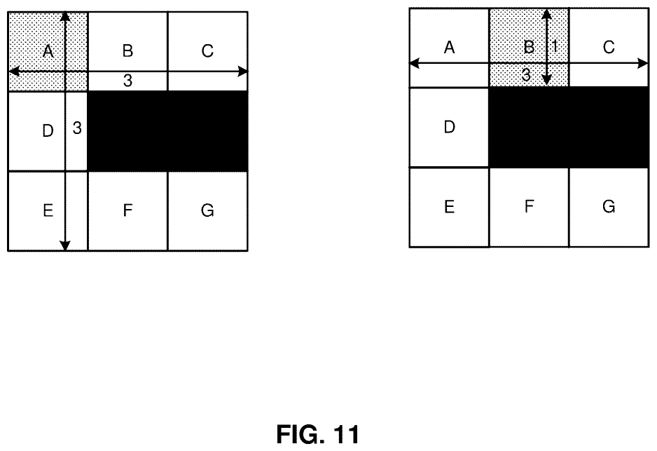

FIG. 11 illustrates logical components in a system configured to calculate the shortest distance and consider the preferred direction (e.g., vertical or horizontal) in accordance with some embodiments. In particular, the FIG. 11 illustrates that vertex A has a distance of three (3) unobstructed nodes in the horizontal direction (e.g., A->B->C) and three (3) unobstructed nodes in the vertical direction (e.g., A->B->E). On the other hand, vertex B has a distance of three (3) unobstructed nodes in the horizontal direction (e.g., A->B->C) but only one (1) unobstructed node in the vertical direction (e.g., B).

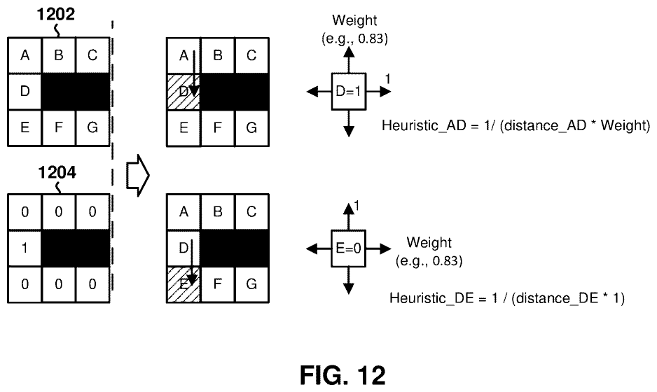

FIG. 12 illustrates logical components in a system configured to use weights for the preferred direction of the vertices in accordance with some embodiments. In the example illustrated in FIG. 12, the system includes a sample map 1202 and a desired direction list 1204 for the corresponding vertex (0 is for vertical and 1 is for horizontal). Each vertex has a preferred direction that indicates the directions to enter/pass through this vertex. The system may use the weights and preferred directions to update the heuristic information. For example, if the path is from vertex A to vertex D, the direction passing through vertex D is vertical, which is equal to the preferred direction of vertex D. In this example, the heuristic between vertex A and D is:

$$Heuristic\_AD = 1 / ( distance\_AD * weight ) .$$

As another example, if the path is from vertex D to vertex E, the direction passing through vertex E is vertical, which is not equal to the preferred direction of vertex E. In this case, the heuristic between vertex D and E is: Heuristic_DE=1/(distance_DE*1). When an ACO path is given (all vertexes are put in order) the system may update the heuristic for every vertex and its neighbors.

The path from vertex A to vertex D is in a vertical direction and the preferred direction of node D is in the vertical direction. As such, in some embodiments, the system may use the preferred weight (e.g., 0.83) value to determine the heuristic value. For example, the system could determine the heuristic as Heuristic_AD=Pheromone_AD/weight.

The path from vertex D to vertex E is also in a vertical direction, but the preferred direction of node E is in the horizontal direction. As such, in some embodiments, the system may use a weight value of one (1) to determine the heuristic value. For example, the system could determine the heuristic as Heuristic_DE=Pheromone_DE/1.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400-500 may be substituted for or combined with one or more operations of the methods 400-500.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before application software is accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a robotic device's processing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method for determining a path for a robotic device, including: obtaining, by a processing device of the robotic device, a navigation map of an environment, in which the navigation map is divided into a grid of vertices, an adjacency list that identifies a distance between each vertex in the grid of vertices and each neighboring vertex that is adject to the vertex, and a super adjacency list that includes elements representing a shortest distance and path turns between each pair of vertices in the navigation map; using the super adjacency list to perform a modified Ant Colony Optimization (ACO) process that generates an ACO path for an ant that starts at a starting vertex and uses heuristic and pheromone values to determine the next vertex to visit until all vertices in the navigation map have been visited; determining a total distance and number of turns in the ACO path; repeating the operations of using the super adjacency list to perform the ACO process and determining the total distance and number of turns in the ACO path traced by an ant until a threshold number of iterations has been performed; sorting ACO paths by distance and number of turns; updating pheromone information associated with each vertex for a fraction of paths with best distance and turn information; and saving one or both of shortest or fastest ACO path in a current iteration.

Example 2. The method of example 1, further including: repeating for a predetermined number of iterations the operations of using the super adjacency list to perform the modified ACO process that generates the ACO path, determining the total distance and number of turns in the ACO path, sorting ACO paths by distance and number of turns, updating pheromone information associated with each vertex for the fraction of paths, and saving one or both of shortest or fastest ACO path in the current iteration; comparing saved ACO paths to determine one or both of a shortest or fastest ACO path; and outputting one or both of a shortest or fastest ACO path.

Example 3. The method of either of examples 1 or 2, further including: dividing the navigation map into the grid of vertices; generating the adjacency list that identifies a distance between each vertex in the grid of vertices and each neighboring vertex that is adject to the vertex; and generating the super adjacency list that includes elements representing a shortest distance and path turns between each pair of vertices in the navigation map.

Example 4. The method of example 3, in which generating the super adjacency list that includes elements representing a shortest distance and path turns between each pair of vertices in the navigation map includes using a A*process applied to the generated adjacency list and to generate the super adjacency list by: determining a shortest path between each pair of vertices in the grid of vertices; determining a number of turns in each shortest path between each pair of vertices in the grid of vertices; and generating the super adjacency list to include the shortest path and the number of turns.

Example 5. The method of example 4, in which generating the super adjacency list further includes: determining a preferred direction of each vertex in the grid of vertices; and associating a weight value to the preferred direction of each vertex in the grid of vertices.

Example 6. The method of any of examples 1-5, further including: determining a pheromone value for each vertex in the grid of vertices; and determining a heuristic value for each vertex in the grid of vertices based on the pheromone value and the weight value of the preferred direction of each vertex in the grid of vertices, in which the determined pheromone value and determined heuristic value are used in the ACO process to determine the path for each ant in a subsequent iteration.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “comparator,” “encoder,” “element” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the following claims and the principles and novel features disclosed herein.

1. A method for determining a path for a robotic device, comprising:
obtaining, by a processing device of the robotic device, a navigation map of an environment, wherein the navigation map is divided into a grid of vertices, an adjacency list that identifies a distance between each vertex in the grid of vertices and each neighboring vertex that is adject to the vertex, and a super adjacency list that includes elements representing a shortest distance and path turns between each pair of vertices in the navigation map;
using the super adjacency list to perform a modified Ant Colony Optimization (ACO) process that generates an ACO path for an ant that starts at a starting vertex and uses heuristic and pheromone values to determine the next vertex to visit until all vertices in the navigation map have been visited;
determining a total distance and number of turns in the ACO path;
repeating the operations of using the super adjacency list to perform the ACO process and determining the total distance and number of turns in the ACO path traced by an ant until a threshold number of iterations has been performed;
sorting ACO paths by distance and number of turns;
updating pheromone information associated with each vertex for a fraction of paths with best distance and turn information; and
saving one or both of shortest or fastest ACO path in a current iteration.

2. The method of claim 1, further comprising:
repeating for a predetermined number of iterations the operations of using the super adjacency list to perform the modified ACO process that generates the ACO path, determining the total distance and number of turns in the ACO path, sorting ACO paths by distance and number of turns, updating pheromone information associated with each vertex for the fraction of paths, and saving one or both of shortest or fastest ACO path in the current iteration;
comparing saved ACO paths to determine one or both of a shortest or fastest ACO path; and
outputting one or both of a shortest or fastest ACO path.

3. The method of claim 1, further comprising:
dividing the navigation map into the grid of vertices;
generating the adjacency list that identifies a distance between each vertex in the grid of vertices and each neighboring vertex that is adject to the vertex; and
generating the super adjacency list that includes elements representing a shortest distance and path turns between each pair of vertices in the navigation map.

4. The method of claim 3, wherein generating the super adjacency list that includes elements representing a shortest distance and path turns between each pair of vertices in the navigation map comprises using a A*process applied to the generated adjacency list and to generate the super adjacency list by:
determining a shortest path between each pair of vertices in the grid of vertices;
determining a number of turns in each shortest path between each pair of vertices in the grid of vertices; and
generating the super adjacency list to include the shortest path and the number of turns.

5. The method of claim 4, wherein generating the super adjacency list further comprises:
determining a preferred direction of each vertex in the grid of vertices; and
associating a weight value to the preferred direction of each vertex in the grid of vertices.

6. The method of claim 5, further comprising:
determining a pheromone value for each vertex in the grid of vertices; and
determining a heuristic value for each vertex in the grid of vertices based on the pheromone value and the weight value of the preferred direction of each vertex in the grid of vertices,
wherein the determined pheromone value and determined heuristic value are used in the ACO process to determine the path for each ant in a subsequent iteration.

7. A computing device, comprising:
a processor configured to:
obtain a navigation map of an environment;
divide the navigation map into a grid of vertices;
generate an adjacency list that identifies a distance between each vertex in the grid of vertices and each neighboring vertex that is adject to the vertex;
use the generated adjacency list and an A*process to generate a super adjacency list; and
use the generated super adjacency list to determine a path through the grid of vertices that visits each vertex in the grid of vertices.

8. The computing device of claim 7, wherein the processor is configured to use the generated adjacency list and the A*process to generate the super adjacency list by:
determining a shortest path between each pair of vertices in the grid of vertices;
determining a number of turns in each shortest path between each pair of vertices in the grid of vertices; and
generating the super adjacency list to include the shortest path and the number of turns.

9. The computing device of claim 8, wherein the processor is further configured to determine the number of turns in each shortest path between each pair of vertices in the grid of vertices by:
determining a preferred direction of each vertex in the grid of vertices; and
associating a weight value to the preferred direction of each vertex in the grid of vertices.

10. The computing device of claim 8, wherein the processor is further configured to:
determine a pheromone value for each vertex in the grid of vertices; and
determine a heuristic value for each vertex in the grid of vertices based on the pheromone value and the weight value of the preferred direction of each vertex in the grid of vertices.

11. The computing device of claim 10, wherein the processor is configured to use the generated super adjacency list to determine the path through the grid of vertices that visits each vertex in the grid of vertices by:
selecting a vertex in the grid of vertices as a starting vertex;
using the super adjacency list to perform a modified Ant Colony Optimization (ACO) process that generates an ACO path for the starting vertex that starts at the starting vertex and uses the heuristic and pheromone values to determine the next vertex to visit until all vertices in the grid of vertices have been visited; and
determining a total distance and number of turns in the ACO path.

12. The computing device of claim 11, wherein the processor is configured to repeat the operations of selecting the vertex in the grid of vertices as the starting vertex, using the super adjacency list to perform the modified ACO process that generates the ACO path, and determining the total distance and number of turns in the ACO path until all of vertices in the grid of vertices have been selected as the starting vertex and an ACO path has been generated for each vertex in the grid of vertices.

13. The computing device of claim 12, wherein the processor is configured to:
generate a sorted list of ACO paths based on the total distance and number of turns associated with each ACO path;
update the pheromone value based on the total distance and number of turns associated with a subset of ACO paths in the sorted list of ACO paths; and
store the shortest ACO path in the sorted list of ACO paths in memory.

14. A computing device, comprising:
means for obtaining a navigation map of an environment;
means for dividing the navigation map into a grid of vertices;
means for generating an adjacency list that identifies a distance between each vertex in the grid of vertices and each neighboring vertex that is adject to the vertex;
means for using the generated adjacency list and an A*process to generate a super adjacency list; and
means for using the generated super adjacency list to determine a path through the grid of vertices that visits each vertex in the grid of vertices.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)
